(19) United States
(12) Patent Application Publication
(10) Pub. No.: US 2009/0259821 A1
(43) Pub. Date: Oct. 15, 2009

(54) APPARATUS AND METHOD FOR MULTIMEDIA COMMUNICATION

(75) Inventors: Mehrad Yasrebi, Austin, TX (US); James Jackson, Austin, TX (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., RENO, NV (US)

(21) Appl. No.: 12/101,213

(22) Filed: Apr. 11, 2008

(51) Int. Cl. G06F 12/00

(52) U.S. Cl. 711/172; 711/E12.002

(57) ABSTRACT

A system that incorporates teachings of the present disclosure may include, for example, a server having a controller to receive media content from a communication device where the media content is to be accessed by one or more recipients, determine a memory capacity available for storage of the media content where the memory capacity is associated with a mailbox of the one or more recipients, and allocate additional memory for storage of at least a portion of the media content, where at least a portion of the additional memory is allocated from memory of a mailbox associated with a sender of the media content. Other embodiments are disclosed.

### FIELD OF THE DISCLOSURE

The present disclosure relates generally to communication services and more specifically to an apparatus and method for multimedia communication.

### BACKGROUND

Sharing of multimedia content among communication devices, including wireless and mobile devices, can be done directly through transmitting the data therebetween. This can be a time-consuming and costly effort. Use of an intermediary, such as an electronic mailbox, can save time and effort but requires the sender or recipients to manage the accessibility of the mailboxes.

### BRIEF DESCRIPTION OF THE DRAWINGS

FIGS. 1-4 depict exemplary embodiments of communication systems;

FIG. 5 depicts an exemplary method operating in portions of the communication systems; and

FIG. 6 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for receiving media content from a communication device where the media content is to be accessed by one or more recipients, determining a memory capacity associated with a mailbox of the one or more recipients, and allocating additional memory for storage of at least a portion of the media content when the memory capacity of the mailbox is below a threshold, where at least a portion of the additional memory is allocated from memory of a mailbox associated with the communication device.

In one embodiment of the present disclosure, a server can have a controller to receive media content from a communication device where the media content is to be accessed by one or more recipients, determine a memory capacity available for storage of the media content where the memory capacity is associated with a mailbox of the one or more recipients, and allocate additional memory for storage of at least a portion of the media content, where at least a portion of the additional memory is allocated from memory of a mailbox associated with the communication device.

In one embodiment of the present disclosure, a server can have a controller to receive media content from a communication device where the media content is to be accessed by one or more recipients, and allocate additional memory for storage of at least a portion of the media content, where the additional memory is from memory of a mailbox associated with the communication device.

In one embodiment of the present disclosure, a communication device can have a controller to transmit media content to a media server, where the media content is accessible by one or more recipients, where at least a portion of the media content is stored in additional memory allocated based on a determination of a memory capacity associated with a mailbox of the one or more recipients being below a threshold level, where at least a portion of the additional memory is provided from a memory source associated with a sender of the media content and the one or more recipients.

In one embodiment of the present disclosure, a method can involve receiving media content from a communication device where the media content is to be accessed by one or more recipients, determining a memory capacity of a mailbox associated with at least one of the one or more recipients and a sender of the media content, and allocating additional memory for storage of at least a portion of the media content when the memory capacity of the mailbox(s) of one or more recipients is below a threshold, where the additional memory is allocated from a memory source associated with the sender of the media content.

It should be understood by one of ordinary skill in the art that the term “at least a portion” of the media content can include some of the media content as well as all of the media content. It should be further understood that the memory of the mailboxes associated with the one or more recipients and/or associated with the communication device is not limited to any particular storage device or numbers of storage devices. The mailboxes can be secured mailboxes that can store message data and files. In one embodiment, the mailboxes can be defined with statically-configured memory spaces which, through use of the computer instructions, method, and devices described herein, can be allocated additional memory for storage of data and files that the mailboxes would normally be unable to store.

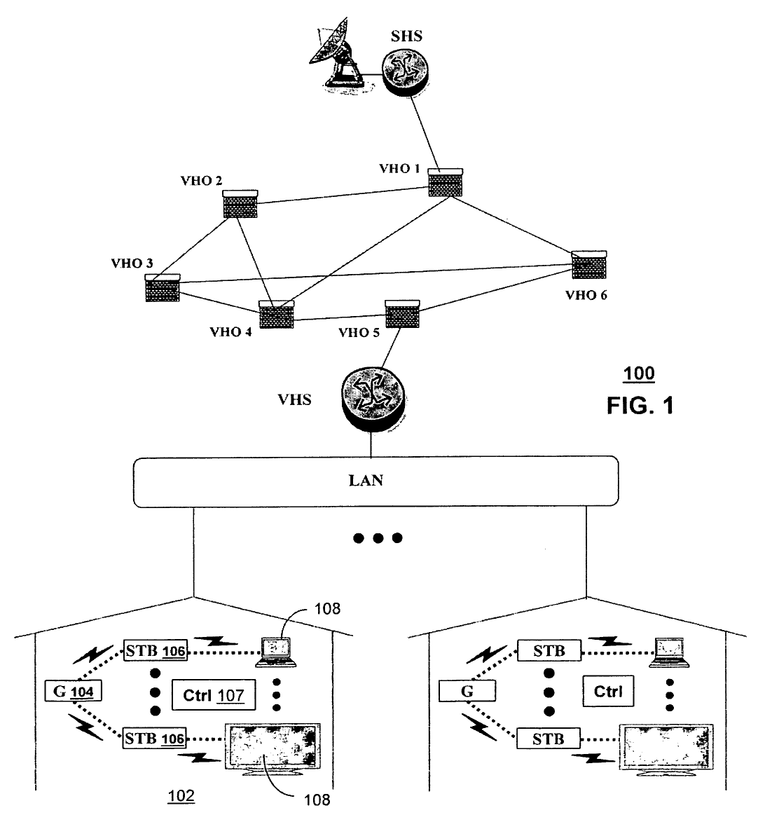

FIG. 1 depicts an exemplary embodiment of a communication system 100 employing an IPTV broadcast media architecture. In a typical IPTV infrastructure, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 102 housing a gateway 104 (e.g., a residential gateway or RG). The gateway 104 distributes broadcast signals to media receivers 106 such as Set-Top Boxes (STBs) which in turn present broadcast selections to media devices 108 such as computers or television units managed in some instances by a media controller 107 (e.g., an infrared or RF remote control). Unicast traffic can also be exchanged between the media receivers 106 and subsystems of the IPTV media system 100 for services such as video-on-demand (VoD).

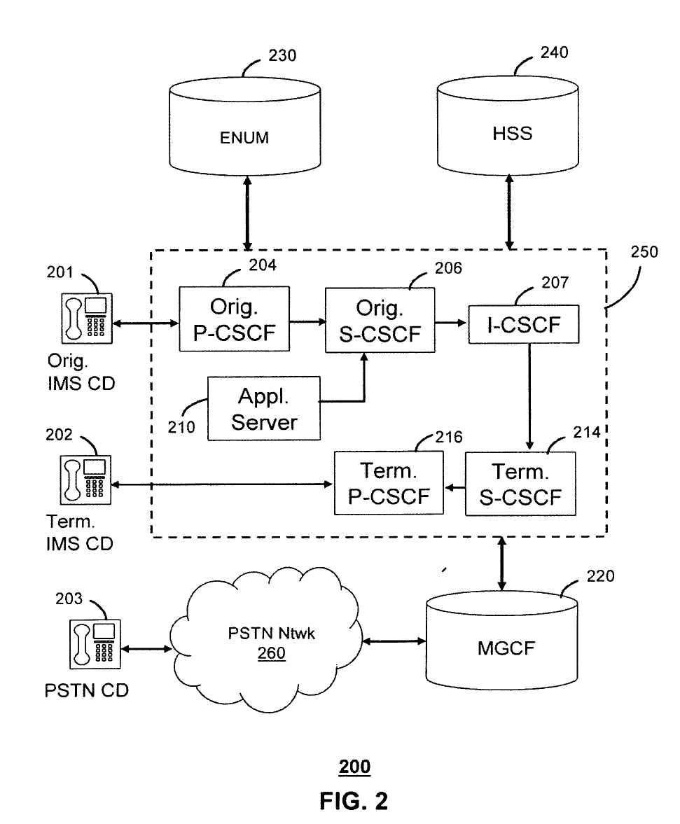

FIG. 2 depicts an exemplary embodiment of a communication system 200 employing a IP Multimedia Subsystem (IMS) network architecture. Communication system 200 can be overlaid or operably coupled with communication system 100 as another representative embodiment of communication system 100.

The communication 200 can comprise a Home Subscriber Server (HSS) 240, a tElephone NUmber Mapping (ENUM) server 230, and network elements of an IMS network 250. The IMS network 250 can be coupled to IMS compliant communication devices (CD) 201, 202 or a Public Switched Telephone Network (PSTN) CD 203 using a Media Gateway Control Function (MGCF) 220 that connects the call through a common PSTN network 260. CDs 201-203 can be fixed, mobile, wireless and/or wired devices.

IMS CDs 201, 202 register with the IMS network 250 by contacting a Proxy Call Session Control Function (P-CSCF) which communicates with a corresponding Serving CSCF (S-CSCF) to register the CDs with an Authentication, Authorization and Accounting (AAA) support by the HSS 240. To accomplish a communication session between CDs, an originating IMS CD 201 can submit a SIP INVITE message to an originating P-CSCF 204 which communicates with a corresponding originating S-CSCF 206. The originating S-CSCF 206 can submit the SIP INVITE message to an application server (AS) such as reference 210 that can provide a variety of services to IMS subscribers. For example, the application 22 server 115 can be used to perform originating treatment functions on the calling party number received by the originating S-CSCF 206 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating SCSCF 206 can submit queries to the ENUM system 230 to translate an E.164 telephone number to a SIP Uniform Resource Identifier (URI) if the targeted communication device is IMS compliant. If the targeted communication device is a PSTN device, the ENUM system 230 will respond with an unsuccessful IP SIP address resolution and the S-CSCF 206 will forward the call to the MGCF 220 via a Breakout Gateway Control Function (not shown).

When the ENUM server 230 returns a SIP URI, the SIP URI is used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214 which can call on an application server similar to reference 210 to perform the originating treatment telephony functions described earlier. The terminating S-CSCF 214 can then identify a terminating P-CSCF 216 associated with the terminating CD 202. The P-CSCF 216 then signals the CD 202 to establish communications. The aforementioned process is symmetrical. Accordingly, the terms “originating” and “terminating” in FIG. 2 can be interchanged.

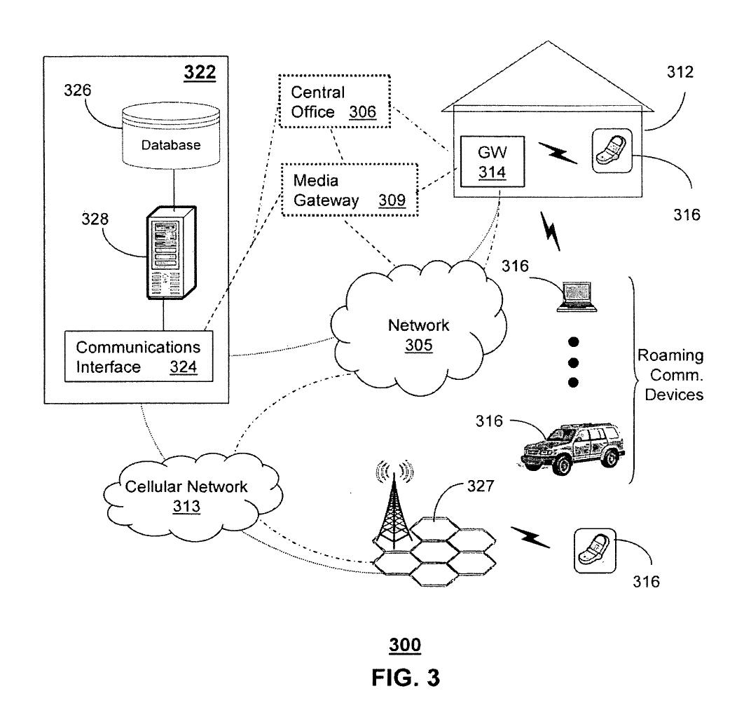

FIG. 3 depicts an exemplary embodiment of a communication system 300 employing fixed and/or mobile communication devices 316 communicating by way of wireless access points (WAPs) and/or wired infrastructure with other communication devices and/or a network proxy or web server 322, which collectively operate in the communication system 300. Communication system 300 can be overlaid or operably coupled with communication systems 100 and/or 200 as another representative embodiment of the communication system.

The communication device 316 can be a multimode communication device, such as a multimode VoIP terminal. However, the present disclosure also contemplates the use of other types of communication devices, including other types of voice, video and data devices. The communication system 300 can comprise a packet-switched network 305. The packet-switched network can bean Internet Service Provider (ISP) network 305. The network 305 can be coupled to the network proxy 322, the cellular network 313 and network elements located in one or more of the buildings 312 representing an enterprise or residence. The ISP network 305 Utilizes technology for transporting Internet traffic.

In an enterprise setting, the building 312 can include a gateway 314 that provides voice and/or video connectivity services between communication devices 316, such as VoIP terminals or other forms of communication devices of enterprise personnel. In a residential setting, the building 312 can include a gateway 314 represented by, for example, a residential gateway coupled to central office 306 utilizing conventional telephonic switching for processing calls with third parties.

The network proxy 322 can be used to control operations of a media gateway 309, the central office 306 and the gateway 314. Communications between the network proxy 322, the communication devices 316 and other network elements of the communication system 300 can conform to any number of signaling protocols such as a session initiation protocol (SIP), SS7, or a video communications protocol such as H.323 which combines video and voice over a packet-switched network, as well as cryptographic protocols, such as transport layer security (TLS) or secure, sockets layer (SSL), to provide secure communications for data transfers.

The network proxy 322 can comprise a communications interface 324 that utilizes common technology for communicating with the network 305, the media gateway 309, the cellular network 313, and/or the gateway 314. By way of the communications interface 324, the network proxy 322 can direct by common means any of the foregoing network elements to establish packet switched data, voice, and/or video connections between communication devices 316 distributed throughout the communication system 300. The network proxy 322 can further comprise a memory 326 (such as a high capacity storage medium) embodied in this illustration as a database, and a controller 328 that makes use of computing technology such as a desktop computer, or scalable server for controlling operations of the network proxy 322. The network proxy 322 can operate as an IP Multimedia Subsystem (IMS) conforming in part to protocols defined by standards bodies such as 3GPP (Third Generation Partnership Protocol).

Under the control of the network proxy 322, the media gateway 309 can link packet-switched and circuit-switched technologies such as the cellular network 313 (or central office 306) and the network 305, such as an ISP network. The media gateway 309 can conform to a media gateway control protocol (MGCP) also known as H.248 defined by work groups in the Internet Engineering Task Force (IETF). This protocol can handle signaling and session management needed during a multimedia conference. The protocol defines a means of communication that converts data from the format required for a circuit-switched network to that required for a packet-switched network. MGCP can therefore be used to set up, maintain, and terminate calls between multiple disparate network elements of the communication system 300. The media gateway 309 can therefore support hybrid communication environments for communication devices 316, including VoIP terminals.

The central office 306 can house common network switching equipment for distributing local and long-distance telecommunication services supplied by network 305 to buildings 312 (such as dwellings or commercial enterprises). Telecommunication services of the central office 306 can include traditional POTS (Plain Old Telephone Service) and broadband services such as HDTV, DSL, VoIP (Voice over Internet Protocol), IPTV (Internet Protocol Television), Internet services, and so on. The communication system 300 can utilize common computing and communications technologies to support circuit-switched and/or packet-switched communications.

The cellular network 313 can support voice and data services over a number of access technologies such as GSM-GPRS, EDGE, CDMA-1X, UMTS, WiMAX, software defined radio (SDR), and other known and future technologies. The cellular network 313 can be coupled to base stations 327 under a frequency-reuse plan for communicating over-the-air with roaming VoIP terminals 316.

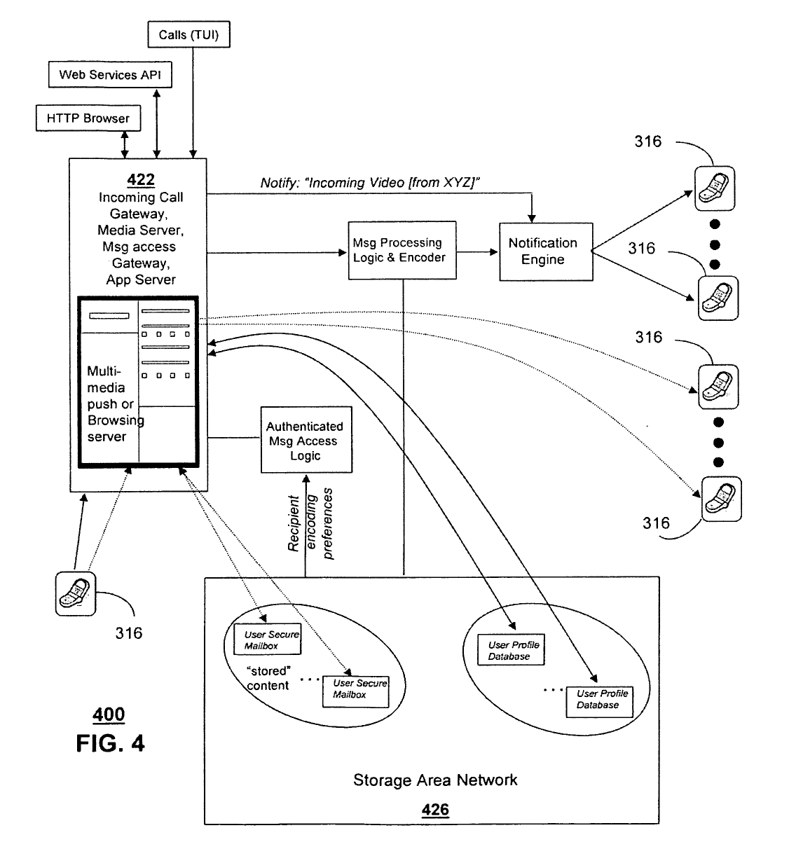

FIG. 4 depicts an exemplary embodiment of a communication system 400 employing fixed and/or mobile communication devices 316 communicating by way of wireless access points (WAPs) and/or wired infrastructure with other communication devices and/or a media server 422, which collectively operate in the communication system 400. Communication system 400 can be overlaid or operably coupled with communication systems 100, 200 and/or 300 as another representative embodiment of the communication system.

Media server 422 can include various components and can utilize various protocols to communicate with a storage area network 426, as well as to communicate with one or more other communication devices 316, such as for distributing multimedia content and transmitting notifications. The media server 422 can include components and technology for reformatting multimedia content, such as according to preferences of a targeted recipient and implementation policies of the provider of the messaging system in the communication system 400. The storage area network 426 can include various components and can utilize various protocols to store data related to users of the communication system 400. For example, the storage area network 426 can include one or more user mailboxes, such as secure mailboxes, which can store various in formation including multimedia content. The storage area network 426 can also include one or more user profiles that can store various information including user preferences, targeted recipients, recipient preferences, and other information. Multimedia content can be delivered/directly to the communication devices 316 from the media server 422 as represented by the dashed lines.

In one embodiment, the user can access his or her mailbox to view the multimedia content, as well as to view information associated with the multimedia content, such as size and format, as well as the status of delivery to or access by targeted recipients. The user can also specify one or more properties associated with the multimedia content, e.g., title, description, and so forth.

In another embodiment, the media server 422 can determine the distribution method to be used for the multimedia content. For example, the multimedia content can be provided to targeted recipients via pull distribution where a message or notification of the existence of the multimedia content is provided to targeted recipients. As another example of a pull distribution, the multimedia content can be transmitted to a mailbox of the targeted recipient for selective access by the targeted recipient, such as a secure user mailbox associated with each or any of targeted recipients in the storage area network 426. As yet another example, the multimedia content can be provided to the targeted recipients via push distribution where the content is transmitted directly to the communication device of the targeted recipient.

The type of distribution can be selected by the sender and/or the recipient associated with the communication device 316 and/or can be determined according to the user profile associated with the communication device 316, as stored in the storage area network 426. For example, the user profile can designate rules for multimedia content distribution according to push, pull or a combination of both. The designated, distribution rules can be based upon the type of media content, the type or identity of the communication device (e.g., a user profile associated with multiple communication devices), the targeted recipients, and/or other factors. For example, a user profile can identify targeted recipients and designate that pull distribution is to be used for those targeted recipients using cellular phones while push distribution is to be used for those targeted recipients using desktop computers. As another example, the type of distribution can be selected by the user of the communication device 316, such as at the time of a distribution request.

The user profiles can be associated with one or more of the sender and the recipients. In one embodiment, a selection of the type of distribution by the user of the communication device 316 can override any distribution designation provided in the user profile of the sender and/or the recipient. For example, a sender's selection of the type of distribution can override any distribution designation provided in the user profile of a recipient and/or a recipient's selection of the type of distribution can override any distribution designation provided in the user profile of a recipient. Rules can be established with respect to the priority of overriding, such as a sender's selection of a type of distribution can override a recipient's selection of the type of distribution.

In one embodiment, a notification or message can be sent to the targeted recipients to advise that the multimedia content is going to be transmitted to the targeted recipients. For example, the push distribution notification can be forwarded to the targeted recipient a particular time period before the transmittal of the multimedia content to allow the targeted recipient to respond by authorizing the push distribution, requesting that the multimedia content not be transmitted, or to request a pull distribution. A notification message can include instructions on how to access the multimedia content. The type of message and means for transmitting the message can be designated in the user profile, such as a message via email, page and/or web services.

In another embodiment, the media server 422 can reformat the multimedia content according to preferences or a desired format stored in the user profile that are associated with the communication devices of the targeted recipients (e.g., a recipient format). For example, a user profile can designate a file format to be used for particular communication devices of the targeted recipients that may only have software that is capable of reading that particular file format. As another example, a user profile can designate targeted recipients that are to receive images of a particular resolution in order to reduce the size of the multimedia content file and facilitate access for the communication device. The degree of reformatting of the multimedia content by the media server 422 can vary from merely adjusting a color contrast or other property of an image (e.g., a resolution) to re-encoding the file for use by a particular communication device. The media server 422 can store each of the reformatted files in the storage area network 426.

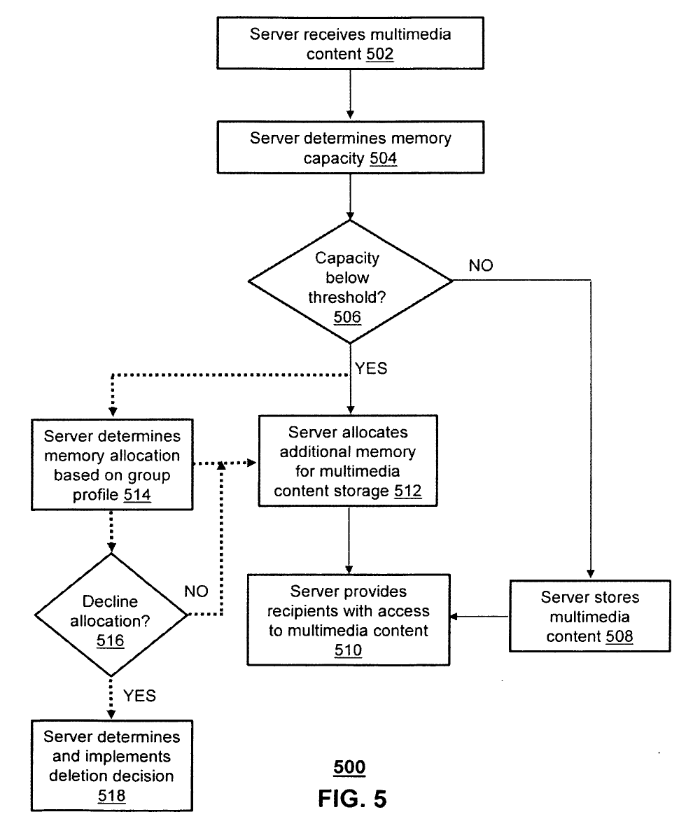

FIG. 5 depicts an exemplary method 500 operating in portions of the communication systems 100-400. Method 500 has variants as depicted by the dashed lines. It would be apparent to an artisan with ordinary skill in the art that other embodiments not depicted in FIG. 5 are possible without departing from the scope of the claims described below. For convenience, the term communication system 400 as used in the following paragraphs can mean communication systems 100, 200, 300 and 400 singly or in combination, and the term communication device 316 can mean communication devices 201, 202, 203 and 316 singly or in combination.

Method 500 begins with step 502 in which the server 422 can obtain multimedia content that is to be stored and/or distributed (e.g. accessible) to the communication devices of one or more recipients. Various media content types are contemplated by the present disclosure, such as moving images, still images, music, video games, and audio, among others.

In step 504, the server 422 can determine the available memory for storage of the media content. For instance, the server 422 can monitor available memory in mailboxes associated with the one or more intended recipients of the media content to determine whether there is enough memory to store the media content. A threshold level can be used in monitoring and determining available memory. The particular threshold can be various amounts including a threshold of zero.

In step 506, the server 422 can determine whether storage of the media content would result in the memory capacity falling below the threshold. If storage of the media content would not leave the memory of the recipient's mailbox below its threshold then in step 508 the server can store the media content and in step 510 access to the media content can be provided to the intended recipients.

If on the other hand, storage of the media content would render the memory of the mailbox below the threshold then in step 512 the server 422 can allocate additional memory for storage of all or some of the media content. The server 422 can then allow the one or more intended recipients to gain access to the multimedia content as in step 510. The allocation of the donated memory can be from a number of sources, including from available memory of the sender and from a temporary pool of memory of the server 422.

In one embodiment, call trees or other user interface schemes (e.g., pop-up interfaces) can be used to determine a message management technique based on the sender's desires. For example, inquiry can be made as to whether the sender wants to donate or otherwise allocate his or her memory space for storing the media content for the intended recipient, or wants to pay for using temporary system space for storing the media content. For instance, the particular option offered may be at the discretion of the service provider. In one embodiment, the service provider can elect to offer this option to its own subscribers only or to other individuals as well.

In one embodiment in step 514, the server 422 can manage memory allocation based on a profile associated with the sender of the media content and/or the intended recipients. For example, as a sender sends a message (e.g., enclosing media content) to each recipient member of the system 400, the server 422 can identify the recipients who do not have enough space to receive such messages. Instead of replying that the recipient does not have enough space, the server 422 can maintain the message in a temporary memory space and compare the telephone number/address of each in-network recipient to the entries of a group profile (e.g., buddy list) of the sender. For each group profile member, the server 422 can invoke a new call tree or other user interface prompt to indicate a number of options, such as: (A) “the recipient does not have enough space to receive your message”; (B) “the recipient is in your group profile list and you have enough personal space to donate to this recipient for this message. Would you like to proceed with the temporary donation of your space for this message?”; (C) “the recipient is in your group profile list, but you do not have enough personal space to donate to this recipient for this message. Would you like us to change your account to use a temporary system space to proceed with the temporary donation that will be available to the recipient for copying to his/her area when he/she accesses it and has room in his/her area at any time during the next number of days?”; and (D) “the recipient is hot in your group profile list. Would you like to use a charge/debit card for use of temporary system space that will be available to the recipient for copying to his/her area when he/she access it and has room in his/her area at any time during the next number of days?” Sample prompts can indicate “X” number of days, where X is any number based on factors including preferences and/or implementation.

In this example, if the sender's response is not to leave a message, then the message can be deleted from the temporary system space. If the sender's response is to use temporary space of the server 422 then the sender can be charged the corresponding fee. The message can be stored in the appropriate space, as elected by the sending user. For each recipient subscriber, a recipient's descriptor list can be updated to include information about management of this message. The sender's descriptor list can also be updated to include information about management of this message. In one embodiment, method 500 can determine if the sender is willing to allocate space as in step 516. In step 518, a decision can be made as to deletion of the message. For example, where a specific deletion decision is made as to particular recipients that do not have enough memory and the sender is unwilling to donate memory, then that particular recipient can be deleted from the list of would be recipients. For other deletion decisions, the message may not be delivered to any of the recipients.

In one embodiment, messages receiving donated or allocated memory can be described and managed using extended and/or new pairs of descriptors. For example, sender message descriptors can be utilized where for each recipient having a message using donated memory an ID/address/telephone number of the recipient can be included; information indicating whether the recipient originally received this message using donated memory; and an identification string of the descriptor for that recipient (e.g., a recipient ID concatenated by a Universally Unique ID (UUID)). The sender message descriptors can also include the location of the message file and message attachments on the system 400.

Available messages can be presented in a number of different ways. For example, an inbox can be populated with messages that have not received donated or allocated memory, as well as with summary information that can be derived from the recipient's descriptor list. Messages that have received donated memory can be highlighted, and can be marked with an expiration date to encourage the recipient to allocate additional room to copy the message to his/her own space. A call tree can search for new descriptors and announce such messages.

In one embodiment, whenever a message that received donated memory is accessed, the status can be updated. If the message is copied over to recipient's own space, the descriptors of senders and recipients can be updated. In another embodiment, the sender can be notified using various communication techniques, such as via e-mail. In one embodiment, when the sender deletes a message that has received donated memory, the space allocated to that message can be re-claimed, and the sender and recipient descriptors of the message can be deleted or updated.

In one embodiment, when a recipient deletes a message that has received donated memory, several steps can be taken in addition to updating the descriptor of the sender. For instance, if this is the last or only recipient, the sender can be notified as such. In one embodiment, all resources associated with the message including the descriptors can be deleted. In another embodiment, the server 422 can await the expiration of the memory donation deadline or a specific action by the sender to remove the message and its resources.

Upon reviewing the aforementioned embodiments, it would be evident to an artisan with ordinary skill in the art that said embodiments can be modified, reduced, or enhanced without departing from the scope and spirit of the claims described below. For examples the donation or allocation of memory can be done from a pool of memory associated with a plurality of subscribers, such as a pool of memory for a group. Each of the members of the group can utilize the pool or a portion thereof to allow for storage of the media content. The pool can be paid for equally be each of the members or can be based on use of the pool. In another example, temporary memory of the server 422 or of other subscribers (e.g., the sender or other recipients) can be utilized to temporarily store the media content for a pre-determined time period so that the intended recipient who lacks the memory capacity can purchase or otherwise obtain the needed memory. For instance, if a message is sent to ten recipients where one of those recipients lacks the memory capacity, one or more of the other recipients can temporarily donate the memory for a limited time period. As another example, one or more recipients can receive notification of the media content, and access to the media content can be provided for the one or more recipients based on purchase of the allocated additional memory by at least one of the sender of the media content and/or the one or more recipients.

The present disclosure also contemplates the entire media content or only a portion thereof being stored in the donated or allocated space. For instance, the server 422 can begin utilizing available storage space of a recipient for storing the media content until all of the recipient's memory capacity has been used, and then can proceed with the steps described above for donating of allocating additional memory to the recipient for storage of the remaining portion of the media content.

These are but a few examples of modifications that can be applied to the present disclosure without departing from the scope of the claims. Accordingly, the reader is directed to the claims section for a fuller understanding of the breadth and scope of the present disclosure.

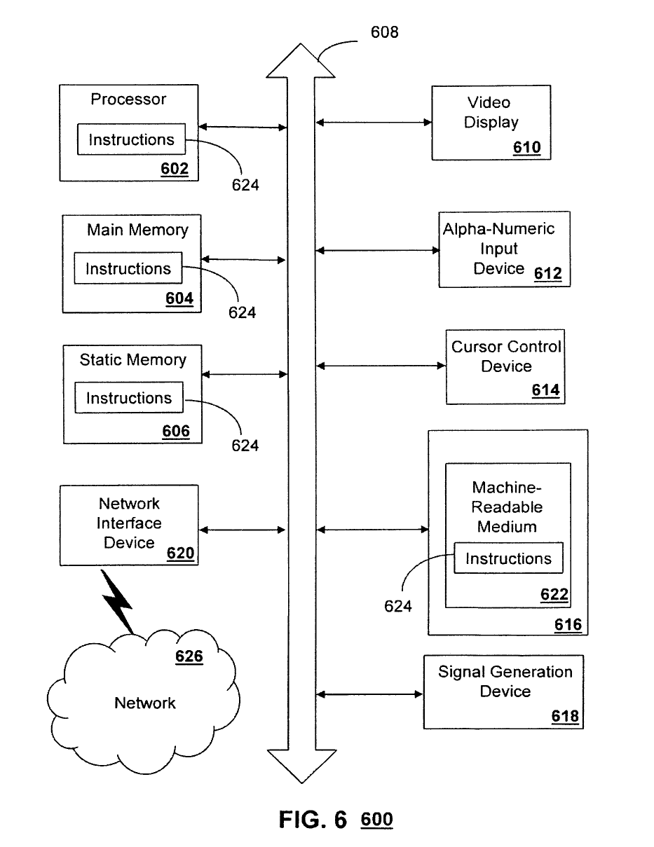

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a mass storage medium 616, a signal generation device 618 (e.g., a speaker or remote control) and a network interface device 620.

The mass storage medium 616 may include a computer-readable storage medium 622 on which is stored one or more sets of instructions (e.g., software 624) embodying any one or more of the methodologies or functions described herein, including those methods illustrated above. The computer-readable storage medium 622 can be an electromechanical medium such as a common disk drive, or a mass storage medium with no moving parts such as Flash or like non-volatile memories. The instructions 624 may also reside, completely or at least partially, within the main memory 604, the static memory 606, and/or within the processor 602 during execution thereof by the computer system 600. The main memory 604 and the processor 602 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the computer-readable storage medium 622 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are riot intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than arc expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
receiving media content from a communication device, the media content to be accessed by one or more recipients;
determining a memory capacity associated with a mailbox of the one or more recipients; and
allocating additional memory for storage of at least a portion of the media content when the memory capacity of the one or more recipients is below a threshold, wherein at least a portion of the additional memory is allocated from memory of a mailbox associated with the communication device.

2. The storage medium of claim 1, comprising computer instructions for providing the one or more recipients with access to the stored media content.

3. The storage medium of claim 1, comprising computer instructions for allocating at least a portion of the additional memory from a pool of memory associated with a sender of the media content and the one or more recipients.

4. The storage medium of claim 1, comprising computer instructions for storing a profile associated with the communication device, wherein the profile comprises an identity of recipients to receive an allocation of additional memory.

5. The storage medium of claim 4, comprising computer instructions for overriding the profile based upon a selection by a sender of the media content of recipients to receive an allocation of additional memory.

6. The storage medium of claim 1, comprising computer instructions for allocating at least a portion of the additional memory from temporary memory of a media server.

7. The storage medium of claim 6, wherein use of the temporary memory is selected by the sender in temporal proximity to transmitting the media content.

8. The storage medium of claim 1, comprising computer instructions for:
storing a profile associated with the communication device, wherein the profile comprises a recipient format preferred by the one or more recipients; and
adjusting a format of the media content according to the recipient format.

9. A server, comprising a controller to:
receive media content from a communication device, the media content to be accessed by one or more recipients;
determine a memory capacity available for storage of the media content, the memory capacity being associated with a mailbox of the one or more recipients; and
allocate additional memory for storage of at least a portion of the media content, wherein at least a portion of the additional memory is allocated from memory of a mailbox associated with a sender of the media content.

10. The server of claim 9, wherein the controller is adapted to:
provide the one or more recipients with notification of the media content;
provide access to the media content for the one or more recipients based on purchase of the allocated additional memory by at least one of the sender of the media content and the one or more recipients.

11. The server of claim 10, wherein the purchase of the allocated additional memory is based on a selection by the one or more recipients in response to the notification, and wherein the additional memory is from a pool of memory associated with the sender and the one or more recipients.

12. The server of claim 9, wherein the controller is adapted to allocate at least a portion of the additional memory from memory of a mailbox associated with the communication device.

13. The server of claim 9, wherein the controller is adapted to store a profile associated with the communication device, and wherein the profile comprises an identity of recipients to receive an allocation of additional memory.

14. The server of claim 9, wherein the controller is adapted to allocate the additional memory from temporary memory, and wherein use of the temporary memory is selected by a sender of the media content in temporal proximity to transmitting the media content.

15. The server of claim 9, wherein the controller is adapted to:
store a profile associated with the communication device, wherein the profile comprises a recipient format preferred by the one or more recipients; and
adjust a format of the media content according to the recipient format.

16. A server, comprising a controller to:
receive media content from a communication device, the media content to be accessed by one or more recipients; and
allocate additional memory for storage of at least a portion of the media content, wherein the additional memory is from memory of a mailbox associated with the communication device.

17. The server of claim 16, wherein the controller is adapted to store a profile associated with the communication device, and wherein the profile comprises an identity of recipients to receive an allocation of additional memory.

18. A communication device, comprising a controller to transmit media content to a media server, the media content being accessible by one or more recipients, wherein at least a portion of the media content is stored in additional memory allocated based on a determination of a memory capacity associated with a mailbox of the one or more recipients being below a threshold level, and wherein at least a portion of the additional memory is provided from a memory source associated with a sender of the media content and the one or more recipients.

19. The communication device of claim 18, wherein the one or more recipients receive notification of the media content; and wherein access to the media content is provided for the one or more recipients based on purchase of the allocated additional memory by at least one of the sender of the media content and the one or more recipients.

20. The communication device of claim 18, wherein a portion of the additional memory is provided from a temporary memory of a media server.

21. The communication device of claim 18, wherein a profile associated with the communication device is stored, and wherein the profile comprises an identity of recipients to receive an allocation of additional memory.

22. A method, comprising:
receiving media content from a communication device, the media content to be accessed by one or more recipients;
determining a memory capacity of a mailbox associated with at least one of the one or more recipients and a sender of the media content; and
allocating additional memory for storage of at least a portion of the media content when the memory capacity of the mailbox is below a threshold, the additional memory being allocated from a memory source associated with the sender of the media content.

23. The method of claim 22, comprising providing the one or more recipients with access to the stored media content.

24. The method of claim 22, wherein the memory source is associated with the one or more recipients.

25. The method of claim 22, comprising storing a profile associated with the sender of the media content, wherein the profile comprises an identity of recipients to receive an allocation of additional memory.
